(19) United States
(12) Patent Application Publication
(10) Pub. No.: US 2011/0310434 A1
(43) Pub. Date: Dec. 22, 2011

(54) PRINTER DRIVER DEVICE, METHOD FOR CONTROLLING PRINTER DRIVER DEVICE, AND IMAGE FORMING SYSTEM

(75) Inventor: Yuusuke Suzuki, Chiba-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/161,660

(22) Filed: Jun. 16, 2011

Related U.S. Application Data
(60) Provisional application No. 61/355,843, filed on Jun. 17, 2010.

(51) Int. Cl. G06K 15/00

(52) U.S. Cl. 358/1.15

(57) ABSTRACT

Disclosed is a printer driver device, including: a first memory unit that stores a kind of application used for creation of document data and page description language used as language at the time of printing the document data in association therewith; a determination unit that determines whether there is a need to rewrite the document data output from the application into the document data by separate page description language based on corresponding information between the kind of application and the page description language stored in the first memory unit; a first output unit that outputs the document data output from the application without changing the page description language, in response to the determination results of the determination unit; and a second output unit that rewrites and outputs the document data output from the application into the document data by the separate page description language, in response to the determination results of the determination unit.

### CROSS-REFERENCE TO RELATED APPLICATION

This application is also based upon and claims the benefit of priority from U.S. provisional application 61/355,843, filed on Jun. 17, 2010; the entire contents of which are incorporated herein by reference.

### FIELD

Embodiments described herein relate to an output method of a printer driver device.

### BACKGROUND

As a driver apparatus for outputting document data to a printer device, there is a driver device including a selection function enabling a user to select page description language used for the document data output to the printer device.

However, it is difficult for a user to select the optimal page description language in response to the kind of the document data. When non-optimal page description language is selected, it is not likely that good quality printed matter will be obtained.

### DESCRIPTION OF THE DRAWINGS

FIG. 1 is a block diagram showing an example of a hardware configuration of an image forming system.

FIG. 2 is a block diagram showing an example of a function of the image forming system.

FIG. 3A is a flow chart showing an operation of the image forming system.

FIG. 3B is a flow chart showing an operation of the image forming system.

FIG. 4 is a data table showing an example of corresponding information.

FIG. 5 is a data table showing an example of a correspondence relationship.

FIG. 6 is a flow of degradation of image quality due to mismatch between a document and a driver.

FIG. 7 is a table in which image defects are arranged.

FIG. 8 is a flow of processing of high image quality according to the present embodiment, in connection with printing of a document including image data having a large size.

### DETAILED DESCRIPTION

A printer driver device according to the present embodiment includes a first memory unit that stores information corresponding to a kind of application used for creation of document data and page description language used as language at the time of printing the document data, a determination unit that determines whether there is a need to rewrite the document data output from the application into the document data using separate page description language based on the corresponding information stored in the first memory unit, a first output unit that outputs the document data output from the application without changing the page description language, in response to the determination results of the determination unit, and a second output unit that rewrites and outputs the document data output from the application into the document data by the separate page description language, in response to the determination results of the determination unit.

### First Embodiment

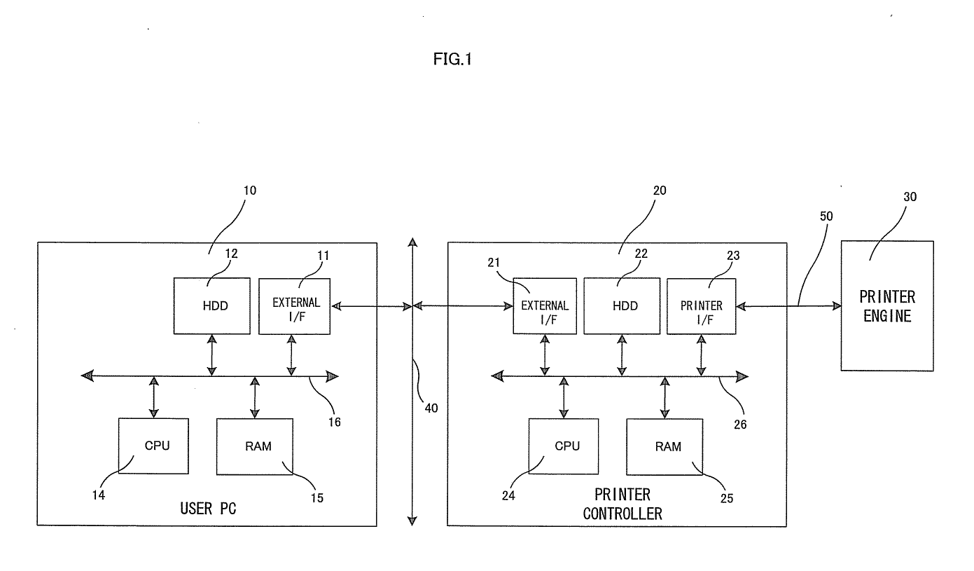

FIG. 1 shows a block diagram of an example of a hardware configuration of an image forming system according to a first embodiment. An image forming system includes a user PC 10, a printer controller 20, and a printer engine 30. The user PC 10 transmits printing information to the printer controller 20. The printer controller 20 converts the printing information received from the user PC 10 into printing image data and outputs the converted printing images to the printer engine 30. The user PC 10 and the printer controller 20 perform communication via a network 40. The printer controller 20 and the printer engine 30 perform high-speed data communication via a communication path 50. The printer controller 20 and the printer engine 30 may be configured integrally with each other or separately from each other.

The printer controller 20 receives an input of PDL data output from the user PC 10, registered fonts, PDL macros, table data for color conversion, or the like, and forms printing images corresponding to input contents according to PJL attached for control or contents of PDL description, or stores the fonts, the macros, and the table data for color conversion therein.

In the user PC 10, an OS is operated. Applications (hereinafter, these may be abbreviated as “apps”) and a printer driver are operated on the OS. When the printing instructions are given by the operation of a user, the printer driver describes the printing contents using the PDL. The OS transmits the PDL data to the printer controller 20 via the network 40. In connection with the transmission of the PDL data, printing data communication protocols are used and data are transmitted by a transmission control according to the protocols. The user may directly describe the PDL data or the application software may create the PDL data without passing through the printer driver. Even in this case, similarly to the case of using the printer driver, the PDL data are transmitted to the printer controller 20 according to a transmission procedure on the basis of the printing data communication protocols by a function provided from the application software for the PDL data transmission and the OS. The user PC 10 is connected to the plurality of networks, each of which transmits the PDL data to the printer controller by the same mechanism described above.

The network 40 may be a network device such as a cable, a router, a gateway, a hub, or a wireless router. The network 40 forms a communication path for performing communication between devices connected via a network device. The user PC 10 and the printer controller 20 are connected to the network 40 by a cable or devices for wireless LAN connection so as to communicate with each other.

The user PC 10 includes an external I/F 11 that communicates with the printer controller 20. The user PC 10 further includes a CPU 14, a RAM 15, and an HDD 12. The components are connected to each other by a communication bus 16 and communicate with the CPU 14. However, in connection with devices other than the RAM 15 and the CPU 14, the devices may perform data communication without passing through the CPU 14 by a direct memory access (DMA) type of communication. A part of the RAM 15 becomes a nonvolatile RAM called NVRAM and holds data even after a power supply is disconnected. The HDD 12 stores driver selection programs. The CPU 14 reads and interprets programs (hereinafter, referred to as the driver selection programs) for selecting an output driver from the HDD 12 on the RAM 15.

The printer controller 20 receives the PDL data transmitted from the user PC 10, and converts the PDL data into the printing images and transmits the converted printing images to the printer engine 30. The processing for forming the printing images is realized by the programs operated therein.

The printer controller 20 includes an external I/F 21 that communicates with PC and a printer I/F 23 that communicates with the printer engine 30 and the programs operated in the printer perform communication using each I/F via the device driver controlling the I/Fs.

The printer controller 20 further includes a CPU 24, a RAM 25, an HDD 22, the external I/F 21, and the printer I/F 23. The components are connected to each other by a communication bus 26 and communicate with the CPU 24. However, in connection with devices other than the RAM 25 and the CPU 24, the devices may perform data communication without passing through the CPU 24 by the communication type of the direct memory access (DMA). The CPU 24 interprets and executes the programs performing the printing processing. The RAM 25 may store the programs relating to the printing processing, the PDL data, the printing images, font data, and working data at the time of executing the programs.

Further, a part of the RAM 25 becomes a nonvolatile RAM called NVRAM and holds data and stores setting information inherent in the printer for printing even after a power supply is disconnected. The HDD 22 stores the received PDL data, resident font, and a conversion table for color conversion, or data in which coefficients are described. The printer controller 20 stores the PDL data in the HDD 22 by executing operation programs called a spooler. Thereby, the CPU can be efficiently used. The communication bus 26 performs communication between other components in the CPU 24 and the printer controller 20 and other components in the printer controller 20 other than the RAM 25 and the CPU 24. A program called a device driver that controls the external I/F 21 and the printer I/F 23 is present on the RAM 25 and the processing is performed via the program when the communication to the network 40 or the communication to the printer engine 30 is performed during the printing processing. The device driver controls the external I/F 21 and the printer I/F 23 and calls the device driver to communicate with an original program and transmit and receive data between respective I/Fs. Thereby, the communication between the user PC 10 and the printer engine 30 by the program operated in the printer controller 20 are realized.

The printer engine 30 communicates with the printer controller 20 via the communication path 50, receives the printing images from the printer controller 20, forms images on a printing medium such as paper using toners of cyan, magenta, yellow, and black, and performs a color printing output on the images.

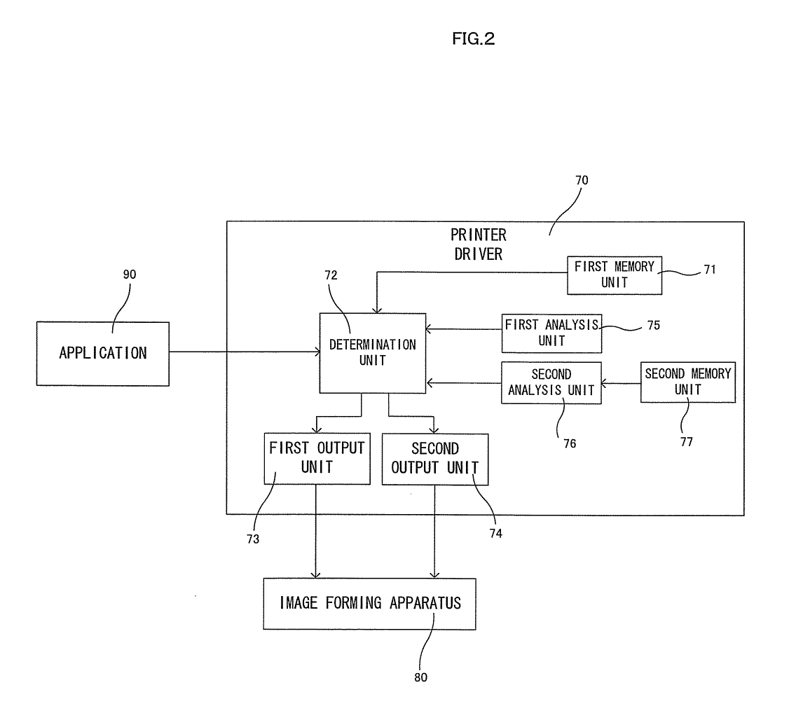

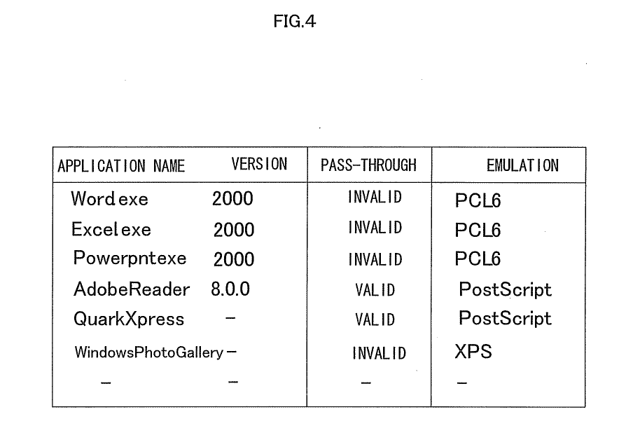

Next, an example of a functional block of the image forming system according to the first embodiment will be described with reference to FIG. 2. The image forming system includes a printer driver 70 and an image forming apparatus 80. The printer driver 70 includes a first memory unit 71, a determination unit 72, a first output unit 73, a second output unit 74, a first analysis unit 75, a second analysis unit 76, and a second memory unit 77. The first memory unit 71 stores information corresponding to a kind of application 90 used for the creation of document data and page description language used as language at the time of printing the document data. FIG. 4 is a data table showing an example of the corresponding information. As shown in FIG. 4, the corresponding information is information that corresponds information regarding an application name and a version of the application 90 used for the creation of the document data to the presence and absence of the pass-through and emulation (page description language).

The determination unit 72 determines whether there is a need to rewrite the document data output from the application 90 into the document data by the separate page description language based on the corresponding information stored in the first memory unit 71.

The first output unit 73 outputs the document data output from the application 90 without changing the page description language, in response to the determination results of the determination unit 72. The second output unit 74 rewrites and outputs the document data output from the application 90 into the document data by the separate page description language, in response to the determination results of the determination unit 72.

The first analysis unit 75 analyzes the application information of the data in a head of the document data when the determination unit 72 determines that there is a need to rewrite into the document data by the separate page description language. The determination unit 72 may perform the determination processing, based on the application specified by the first analysis unit 75 and the corresponding information stored in the first memory unit 71.

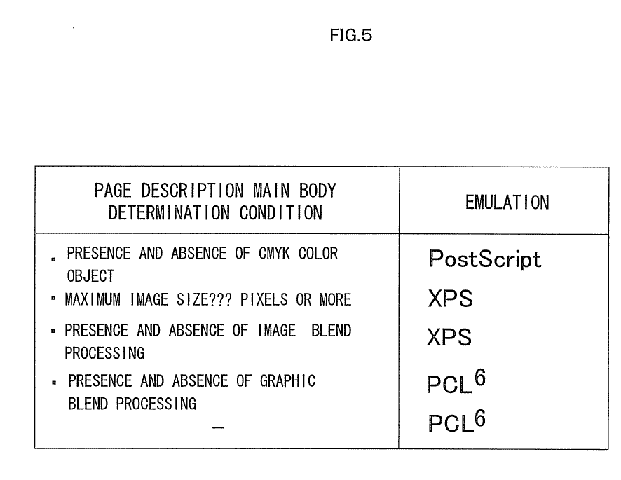

The second analysis unit 76 analyzes all the document data when the determination unit 72 determines that the corresponding information regarding the application specified by the first analysis unit 75 is not stored in the first memory unit 71 and selects the page description language based on the analysis results. In detail, an appropriate page description language may be selected based on the correspondence relationship between the analysis results and the page description language. The second memory unit 77 stores the information regarding the correspondence relationship. FIG. 5 is a data table showing an example of the correspondence relationship. The data table shows a relationship between determination conditions including presence and absence of a CMYK color object, a maximum image size, presence and absence of image a blend processing, and presence and absence of graphic a blend processing and the page description language to be used.

In this configuration, the correspondence relationship between the hardware configuration of FIG. 1 and the functional block of FIG. 2 is described. The printer driver 70 may be mounted with the user PC 10. The determination unit 72, the first analysis unit 75, and the second analysis unit 76 may also be the CPU 14. However, the determination unit 72, the first analysis unit 75, and the second analysis unit 76 may include an ASIC circuit that executes at least one of the processes realized in the CPU 14 in circuit. The first memory unit 71 and the second memory 77 may be realized in cooperation with the HDD 12 and the RAM 15.

The first output unit 73 and the second output unit 74 may be realized in cooperation with the external I/F 11 and the communication bus 16.

The image forming apparatus 80 may be realized by cooperation of the printer controller 20 and the printer engine 30.

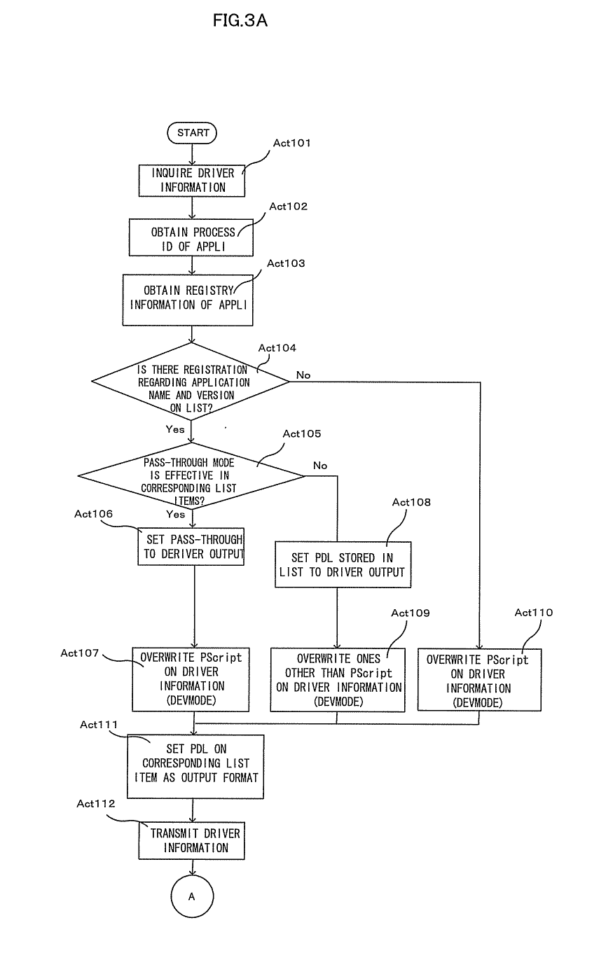

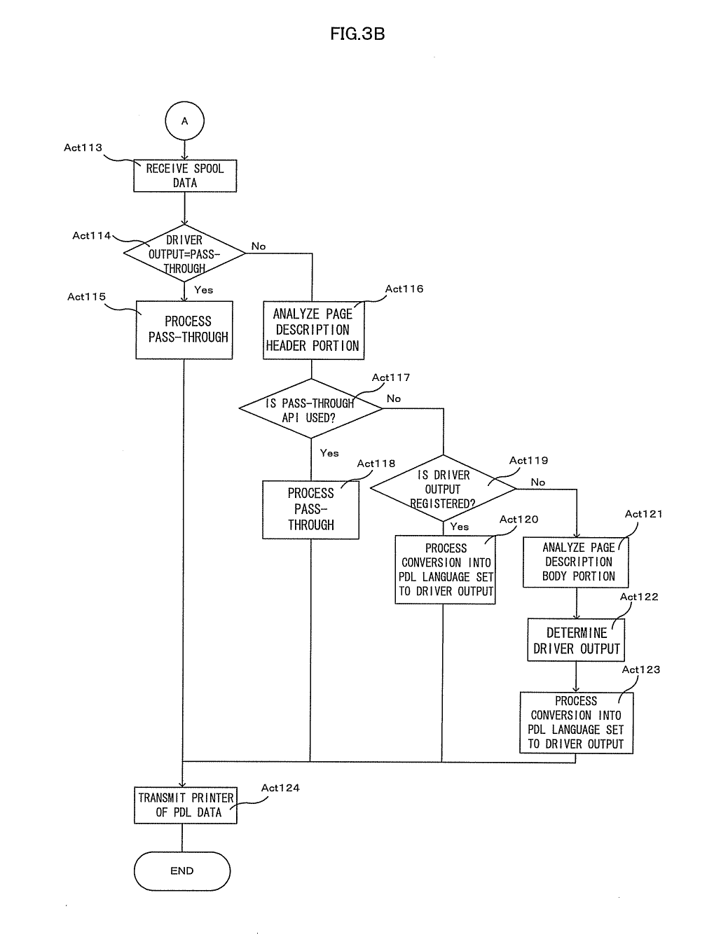

Next, the operation of the image forming system according to the first embodiment will be described. FIGS. 3A and 3B are flow charts showing the operation of the image forming system. Referring to FIG. 3A, in Act 101, the application makes an inquiry about the driver information to the printer driver 70. In this case, the driver information in question may be information regarding functions included in the printer and presence and absence of Nup, color/monochrome, staple, or the like. Among them, the information for determining whether the printer driver 70 includes the kind of the printer driver 70 and the function (pass-through function) of outputting the PDL data as they are, without performing the processing on the PDL data output by the application 90 is included.

In Act 102, the printer driver 70 obtains process management ID information that is managed by the OS of the inquired application.

In Act 103, the printer driver 70 inquires the information regarding the application on the basis of the process management ID obtained in Act 102. The information may include the application name, or the like, that specifies the application 90. The printer driver 70 makes the inquiry to a database of the application information managed in the system using the application name obtained as described above as a key to obtain the version information of the application.

Next, the PDL is determined by using the obtained application name and the version name as the key and the PDL determination data table of FIG. 4. In detail, in Act 104, the printer driver 70 determines whether there is the registration information corresponding to the application name and the version information obtained in Act 103 by referring to the PDL determination data table of FIG. 4. If it is determined that there is the registration information in Act 104, the process proceeds to Act 105, but if it is determined that there is no registration information, the process proceeds to Act 110.

Whether the pass-through mode is effective is determined in Act 105. If it is determined that the pass-through mode is effective, the process proceeds to Act 106 and if it is determined that the pass-through mode is not effective, the process proceeds to Act 108.

In Act 106, the printer driver 70 sets the pass-through mode as the output mode and the process proceeds to Act 107. In Act 107, the printer driver 70 overwrites a character string (PSCRIPT) indicating the pass-through mode correspondence, in connection with the information (DEVMODE structure) transmitted to the app. In this case, for example, the application made from Adobe (Trademark, the same applies hereinbelow) has the function of directly outputting PostScript (Trademark, the same applies hereinbelow) data and improves the compatibility of the display and the printing contents by this function. For this reason, for the application made by Adobe, the pass-through is effectively set as shown in the data table of FIG. 4.

In Act 108, the printer driver 70 sets the PDL in the data table of FIG. 4 as an output mode and the process proceeds to Act 109. For example, for Word. exe of version 2000, PCL6 is set as the PDL. In Act 109, the printer driver 70 overwrites the character string indicating the correspondence other than the pass-through mode, in connection with the information transmitted to the app.

In Act 110 (Act 104, No), the printer driver 70 overwrites the character string (PSCRIPT) indicating the pass-through mode correspondence, in connection with the information (DEVMODE structure) transmitted to the app.

In Act 111, the printer driver 70 sets the PDLs corresponding to each application as an output mode by referring to the data table of FIG. 4 and the process proceeds to Act 112. Herein, in the case where there is no information regarding the application in the data table of FIG. 4, that is, in Act 104, in the case of No, the PDL of the set default is set.

In Act 112, the printer driver 70 transmits the information regarding the PDL and the presence and absence of the pass-through mode to the app. In this case, when the printer driver corresponds to the pass-through and the application is Adobe (for example, Acrobat (Trademark, the same applies hereinbelow), Illustrator (Trademark, the same applies hereinbelow), or the like), the application outputs all the drawing contents by PostScript, based on the information transmitted from the printer driver. The application outputs only special images by PostScript and outputs all the other images by GDI, based on the information transmitted from the printer driver, when the printer driver corresponds to the pass-through and the application is MS Office. The application outputs all the drawing contents with the GDIs based on the information transmitted from the printer driver 70, when the printer driver 70 does not correspond to the pass-through.

The process returns to the processing performed by the printer driver 70. Referring to FIG. 3B, when the printer driver 70 receives the drawing contents of the document transmitted from the application in Act 113, the process proceeds to Act 114.

In Act 114, the printer driver 70 determines whether the information regarding the pass-through mode is included in the information transmitted from the app. If it is determined that the information regarding the pass-through mode is included in the information transmitted from the application, the process proceeds to Act 115. On the other hand, if it is determined that the information regarding the pass-through mode is not included in the information transmitted from the application, the process proceeds to Act 116. In the first embodiment, the pass-through processing is performed on the drawing contents output from Adobe app.

In Act 115, the printer driver 70 transmits the drawing contents received from the application to the image forming apparatus 80 as they are. That is, in the case of the pass-through mode, the application transmits the directly output PDL language data to the image forming apparatus 80.

In Act 116, the printer driver 70 analyzes a head portion (header information) of the information transmitted from the application and the process proceeds to Act 117. In Act 117, the printer driver 70 determines whether the application to be subjected to the pass-through is used, based on the analysis results of Act 116. If it is determined that the application to be subjected to the pass-through is used, the process proceeds to Act 118. On the other hand, if it is determined that the application to be subjected to the pass-through is not used, the process proceeds to Act 119. For example, when the drawing data of the head portion are created by PostScript, it is determined that the application to be subjected to the pass-through is used.

In Act 118, the printer driver 70 transmits the drawing contents received from the application to the image forming apparatus 80 as they are. In Act 119, the printer driver 70 determines whether the drawing contents to be output are registered by referring to the data table of FIG. 4. If it is determined that the drawing contents to be output are registered, the process proceeds to Act 120. On the other hand, if it is determined that the drawing contents to be output are not registered, the process proceeds to Act 121.

The printer driver 70 performs the conversion into the predetermined PDL data according to the data table of FIG. 4 in Act 120 and outputs the converted PDL data to the image forming apparatus 80 in Act 124.

In Act 121, the printer driver 70 determines whether the description contents match “the determination conditions of the page description main body” shown in FIG. 5 and the process proceeds to Act 122. Further, “the determination conditions of the page description main body” shown in FIG. 5 will be described in a detailed example to be described below. In Act 122, the printer driver 70 determines the driver output and the process proceeds to Act 123. In Act 123, the printer driver 70 performs the conversion into the predetermined PDL data based on the set driver output and outputs the converted PDL data to the image forming apparatus 80, in Act 124.

Hereinafter, how to process the detailed printing application or document is described in the first embodiment.

The first case is a case in which translucence is used in the application handling graphics. The image defects called blurring or jaggedness due to moiré or degradation in resolution may occur in the translucent portion due to a combination of the application and the mounting method of the printer driver. The method of the present type avoids the defects of the image quality by switching the driver in response to the application.

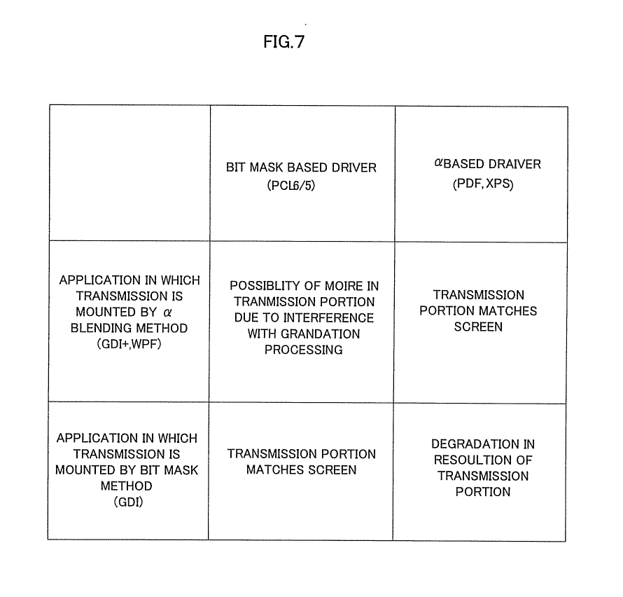

FIG. 7 is a table arranging the image defects that may occur when the translucent processing is realized by a a blending type (a type realizing transparency by a loading average of a pixel value) or a bit mask type (a type realizing transparency by masking a transmissive area by a pixel pattern). Basically, when the realization methods of the application and the transmissive portion of the printer driver are the same as each other, in detail, in the case of the a blending together with the application the driver and the bit mask together with the app the driver, the image defects do not occur. On the other hand, the realization methods of the translucency of the app the driver are different from each other, it is likely to cause the image quality defects depending on the content. When the application realizes that the transmission of the bit mask and the driver realized by the α blending, since the object first masked in a pixel unit in the application is subjected to the gradation processing by the driver or the printer controller, even though the transmission seems to be processed on the screen without causing any problems it is likely to cause the interference between the bit mask pattern and the gradation processing pattern and cause the moiré in the transmissive portion, when viewing the printing output. Further, when the application realizes the transmissive portion by the α blending and the driver realizes the transmissive portion by the bit mask, the bitmapping for color mixing processing of a transmissive portion is performed on the application side. However, since the resolution of the bitmap is lower than that of the printer, it is likely to cause the blurring and the jaggedness in the transmissive portion.

In connection with the above problems, in the first embodiment, the realization method of the translucent processing of the application may greatly depend on the kind of the API used when the application is mounted, and the method registers the information of the API previously used by corresponding the application name to the table of FIG. 4 and selects the driver based on the registered information. In detail, the kind of the application and the driver (PDL) are registered as the bit mask since the printing from the application using the API of the GDI is highly likely to realize the transmission as the bit mask processing and are registered by the α blending since the printing from the application using the API of the GDI+ WPF is highly likely to use the a blending. In this connection, since a PCL6 driver performs the bit mask on the transmissive portion, the PCL6 driver is registered as the printer driver from the GDI-based application and since a PDF/XPS driver corresponds to the α blending of the transmissive portion, the PDF/XPS driver is registered in the table as the printer driver from the GDI+/WPF-based app. Thereby, the transmissive realization methods of the application and the driver match each other and the image defects are suppressed. As a result, the user automatically avoids the defects of the image quality regarding the translucency and performs the printing at the good quality of image, even without the application or the printer driver.

The second case is a case regarding the printing from the application having an embedding function such as the gradation pattern specified command of the PostScript. The Postscript that is a kind of PDL greatly supports a command capable of adjusting fine parameters associated with the printing and the case in which a high level of publishing application used by the user in connection with publication and design includes a UI that sets parameters corresponding to the PostScript commands from the application on UI occurs frequently. However, when the printing is performed using a publishing software by the PDL (PCL, XPS, or the like) other than the PostScript, the parameters set by the UI may be disregarded or the substitution into the non-compatible function may occur, or the like, thereby causing problems in image quality and stability, such as the distortion of the screen, or printing errors. For this reason, in the present type, the application name using the unique function of the PostScript is registered and the PostScript driver is set as the corresponding driver, in a place of the application name of the table of FIG. 4. Thereby, the printing from the application using the function of the PostScript is printed from the PostScript driver and the printing is executed while automatically avoiding the defects due to mismatching of the functions of the application and the driver.

The third case is a case in which the improvement of the image quality is performed by using the high level of function that is supported only by a specific language such as a JPEGXR format supported by an XPS driver using the automatic selection of the driver according to the printing contents. The JPEGXR is a file format of the image data. There is a merit in which a higher quality of image compression may be realized, as compared with JPEG having the same size.

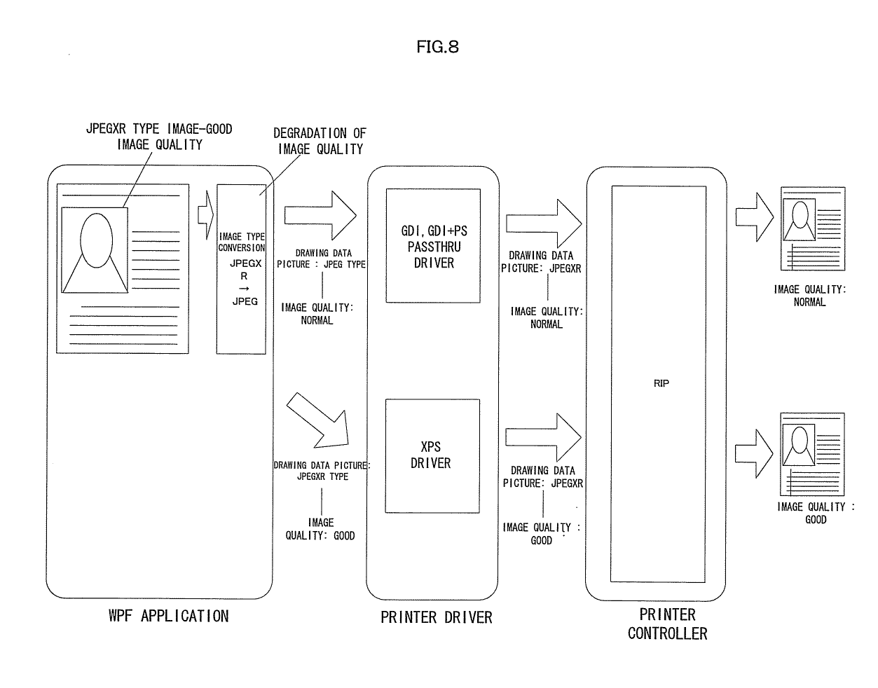

FIG. 8 shows a flow of processing of increasing image quality to which the first embodiment is applied, in connection with the printing of the document including the image data having a large size. In the first embodiment, the processing is executed according to a flow shown on the bottom side of FIG. 8. In the flow, the image portion is printed with a high image quality by performing the printing using the XPS driver supporting the JPEGXR format. As compared with this, in the driver using the JPEG according to the related art, the image quality stays at the level of the related art. In connection with the mounting, for the table of FIG. 5 using the processing of analyzing the PDL, when the image size is equal to or greater than a predetermined value, the XPS is registered as the determination conditions of the page description so that the image is compressed by the JPEGXR as described above. Thereby, the high quality image attached to the document image is printed while suppressing deterioration.

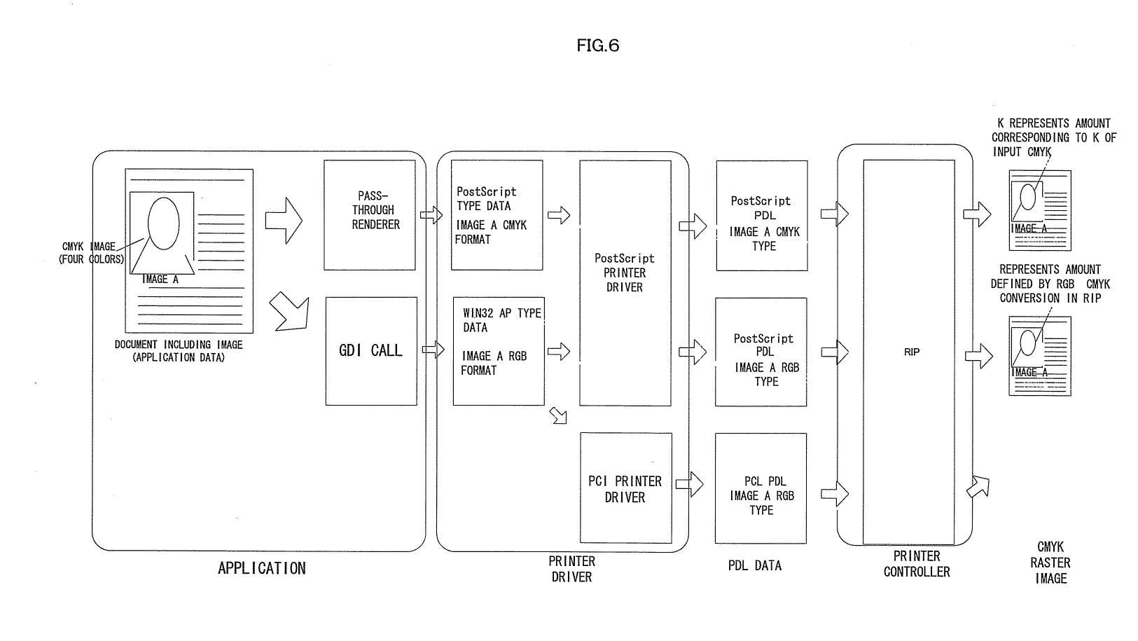

The fourth case is a case of performing the printing by the PDL supporting the CMYK colors when there is a drawing object of the CMYK colors in the document. In the document to be printed, the object may be input by the CMYK colors for the purpose of realizing high quality by controlling the colors of colorplates. When a user that does not have knowledge regarding colors prints the document with a driver such as the PCL that does not support CMYK, the information of K colorplate is removed and the document becomes loose. FIG. 6 shows a flow of the degradation in image quality due to the mismatching of the document and the driver. In the format conversion at the previous stage of the printer driver of FIG. 6, when the printing from the GDI-based API is performed, since the image is substituted into the entire RGB format, the situation of the K colorplate is lost and as described above, the image quality defects occur.

In the printing of the document including the drawing object represented by the CMYK, in order to avoid the loss of the K colorplate information according to the above-mentioned format conversion, the first embodiment is configured in connection with the determination conditions of FIG. 5 such that the presence of the CMYK object is registered as the determination condition and the PostScript is registered as the language to be selected, as shown in FIG. 5, in order to select the PostScript supporting the CMYK colors and performs printing when the PDL is searched and a CMYK object is found in the document. Thereby, when the CMYK object is included in the document, since the PostScript language supporting the CMYK is automatically selected and printing is performed, a user that does not have the knowledge regarding the color or the data format may print the document at a desired quality.

The present disclosure can be practiced in various forms without departing from the spirits or main characteristics thereof. For this reason, the foregoing embodiment is only an example in all aspects and therefore, is not to be construed as being limited. The scope of the present disclosure is presented by the scope of claims and is therefore not limited by the specification. Further, all the changes, various modifications, replacements, and improvements belonging to equivalents to the scope of claims are to be construed as being included in the scope of the present disclosure.

### Reference Example

Although the foregoing embodiment describes the configuration originally outputting the document data in which the path through is set from the driver, a configuration selecting the appropriate page description language according to the results of analyzing all the document data by the first analysis unit 75 and the second analysis unit 76 may be allowed.

What is claimed is:

1. A printer driver device, comprising:
a first memory unit that stores a kind of application used for creation of document data and page description language used as language at the time of printing the document data in association therewith;
a determination unit that determines whether there is a need to rewrite the document data output from the application into the document data by separate page description language based on corresponding information between the kind of application and the page description language stored in the first memory unit;
a first output unit that outputs the document data output from the application without changing the page description language, in response to the determination results of the determination unit; and
a second output unit that rewrites and outputs the document data output from the application into the document data by the separate page description language, in response to the determination results of the determination unit.

2. The device according to claim 1, wherein the application outputs determination information for determining whether there is a need to rewrite into the document data by the separate page description language, together with the document data output to the printer driver device.

3. The device according to claim 2, wherein the determination information is character string information.

4. The device according to claim 2, further comprising a first analysis unit that analyzes application information of data in a header of the document data, when the determination unit determines that there is a need to rewrite into the document data by the separate page description language.

5. The device according to claim 4, wherein the determination unit performs the determination processing, based on the application specified by the first analysis unit and the corresponding information stored in the first memory unit.

6. The device according to claim 5, further comprising a second analysis unit that analyzes all the document data and selects the page description language based on the analysis results, when the determination unit determines that the corresponding information regarding the application specified by the first analysis unit is not stored in the first memory unit.

7. The device according to claim 6, further comprising a second memory unit that stores a correspondence relationship between the analysis results and the page description language by the second analysis unit.

8. The device according to claim 7, wherein the second memory unit stores a relationship between determination conditions at least including presence and absence of a CMYK color object, a maximum image size, presence and absence of image a blend processing, and presence and absence of graphic a blend processing and the page description language to be used.

9. A method for controlling a printer driver device, comprising:
storing a kind of application used for creation of document data and page description language used as language at the time of printing the document data in association therewith;
determining whether there is a need to rewrite the document data output from the application into the document data by separate page descriptive language based on corresponding information between the kind of application and the page description language;
outputting the document data output from the application from a first output unit without changing the page description language, in response to the determination results; and
rewriting the document data output from the application into the document data by the separate page description language, in response to the determination results and outputting the document data from a second output unit.

10. The method according to claim 9, wherein the application outputs determination information for determining whether there is a need to rewrite the document data by the separate page description language, together with the document data output to the printer driver device.

11. The method according to claim 10, wherein the determination information is character string information.

12. The method according to claim 10, further comprising analyzing application information of data in a header of the document data, when the determination unit determines that there is a need to rewrite into the document data by the separate page description language.

13. The method according to claim 12, further comprising performing the determination, based on the application specified by the analysis and the corresponding information.

14. The method according to claim 13, further comprising analyzing all the document data and selecting the page description language based on the analysis results, when there is no corresponding information regarding the application specified by the analysis.

15. The method according to claim 14, further comprising selecting the page description language based on the relationship information storing the correspondence relationship between the analysis results and the page description language.

16. The method according to claim 15, wherein the relationship information is information regarding the correspondence relationship between determination conditions at least including presence and absence of a CMYK color object, a maximum image size, presence and absence of image a blend processing, and presence and absence of graphic a blend processing and the page description language to be used.

17. An image forming system, comprising:
a printer driver device that includes a first memory unit that stores a kind of application used for creation of document data and page description language used as language at the time of printing the document data in association therewith, a determination unit that determines whether there is a need to rewrite the document data output from the application into the document data by separate page description language based on corresponding information between the kind of application and the page description language stored in the first memory unit, a first output unit that outputs the document data output from the application without changing the page description language, in response to the determination results of the determination unit, and a second output unit that rewrites and outputs the document data output from the application into the document data by the separate page description language, in response to the determination results of the determination unit; and
an image forming apparatus that forms images, based on the document data output from the printing driver apparatus.

18. The system according to claim 17, wherein the application outputs determination information for determining whether there is a need to rewrite into the document data by the separate page description language, together with the document data output to the printer driver device.

19. The system according to claim 18, wherein the determination information is character string information.

20. The system according to claim 18, further comprising a first analysis unit that analyzes application information of data in a header of the document data, when the determination unit determines that there is a need to rewrite into the document data by the separate page description language.
